(19) United States
(12) Patent Application Publication
(10) Pub. No.: US 2013/0093192 A1
(43) Pub. Date: Apr. 18, 2013

(54) Decoupled, fluid displacer, sterling engine

(71) Applicant: John Lee Warren, Melville (CA)

(72) Inventor: John Lee Warren, Melville (CA)

(21) Appl. No.: 13/373,447

(22) Filed: Nov. 15, 2011

Related U.S. Application Data
(60) Provisional application No. 61/548,589, filed on Oct. 18, 2011.

(51) Int. Cl. F03G 7/04; H02K 7/18; F02G 1/055

(52) U.S. Cl. 290/1 A; 60/641.2; 60/517

(57) ABSTRACT

A mechanically decoupled, fluid displacing Sterling engine includes first and second containers, first and second fluid conduits mounted to the containers, a pump mounted in cooperation with the second conduit for selectively pumping fluid between the containers, a processor controlling the pump, a third fluid conduit whose lower end extends into the lower end of the second container, a fluid motivated actuator mounted to the third conduit. The first and second containers contain an actuating volume of an actuating fluid and a working gas. Expanding of the gas actuates the actuator. The volume of the containers is pressurized by a geothermal temperature differential. The pump displaces the actuating fluid between the containers so as to correspondingly displace the gas for heating or cooling to provide the temperature differential to the gas.

### CROSS REFERENCE TO RELATED APPLICATION

This application claims priority from U.S. Provisional Patent Application No. 61/548,589 filed. Oct. 18, 2011 entitled A DECOUPLED, FLUID DISPLACER, STERLING ENGINE.

### FIELD OF THE INVENTION

This invention relates to the field of devices utilizing Sterling engines and in particular to a mechanically de-coupled fluid displacing Sterling engine.

### BACKGROUND OF THE INVENTION

Sterling engines have been around for over two hundred years. Recently, efficiencies of operation have increased where low temperature differential Sterling engines now routinely operate at temperature differentials of five degrees Celsius. These temperature differentials may be found in geo-thermal applications where in summer an above ground temperature is five degrees higher an underground temperature, and vice-versa in winter.

In the present invention a low temperature differential Sterling engine has portion of the engine underground, i.e. the hot side in the winter season, and the remainder of the engine on the surface, i.e. the cold side in winter. In this scenario, the displacer would have to travel a great distance, and would be very heavy. A mechanical linkage, of such a typical mechanism, from a driven flywheel to the displacer would be very cumbersome. It is consequently one object of the present invention use the Sterling engine to displace fluid over a distance to provide for pressurized actuation of an actuator such as a piston.

### SUMMARY OF THE INVENTION

In the summary, the mechanically decoupled, fluid displacing Sterling engine according to one aspect of the present invention may be characterized as including:
(a) hollow first and second containers, each of the containers having opposite upper and lower ends;
(b) first and second fluid conduits mounted to, so as to extend between in fluid communication with, the first and second containers;
(c) a selectively actuable fluid pump mounted in cooperation with the second conduit, the fluid pump adapted to selectively pump fluid between the containers;
(d) a processor cooperating with the fluid pump, the processor adapted to control the pumping by the fluid pump;
(e) a third fluid conduit having opposite first and second ends, the first end of the third conduit extending into the lower end of the second container, a fluid motivated actuator mounted to, in fluid communication with, the second end of the third conduit,

The first conduit only extends into the upper ends of the containers, and the second conduit extends into the lower ends of the containers. The first and second containers contain an actuating volume of an actuating fluid. The balance of the volume of the containers contains a working gas. The gas is expandable and contractable upon heating and cooling of the gas respectively. The actuating volume of the actuating fluid is sufficient for pumping of the fluid between the containers and for actuation of the fluid along the third conduit, whereby the expanding of the gas urges a power stroke translation of the actuator, and the volume of the containers is pressurized upon a temperature differential being applied to the first and second containers to cause the expansion of the gas. Advantageously the temperature differential is a geothermal temperature differential. The pumping displaces the actuating fluid between the containers so as to correspondingly displace the gas for heating or cooling to provide the temperature differential to the gas.

In a preferred embodiment the containers are hot and cold chambers of a Sterling engine, wherein the first chamber is adapted to be installed in-ground, and the second container is adapted to be mounted above ground. During a cold season the second container is the cold chamber and the first container is the hot chamber. During a warm season the first container is the cold chamber and the second chamber is the hot chamber. The processor is adapted to cause the pump to pump the actuating fluid into the cold chamber to thereby drive the gas into the hot chamber to increase the pressurization and the actuation of the actuator in the power stroke and to pump the actuating fluid into the hot chamber to thereby drive the gas into the cold chamber to reduce the pressurization and permit a reverse retracting translation of the actuator, whereby a net gain in work as between the power stroke and the pumping of the fluid is achieved.

In one embodiment the first conduit has opposite ends which are oriented so as to direct a flow of the gas from each the end against an adjacent wall of the container so as to increase a rate of heat exchange between the flow and the adjacent wall. For example, the containers may have curved interior surfaces and the ends of the first conduit direct the flow at an acute angle against the curved interior surfaces. Depending on the shape of the containers, the flow may advantageously induce a swirling flow in the containers. The ends may be nozzles, and the containers may be cylindrical.

The actuator may be a piston. The actuating fluid may be a liquid. The cold chamber may include heat radiating members, for example, fins.

The engine may further include a flywheel cooperating with, so as to be driven by, the piston. Sensors may be provided cooperating with the flywheel. The sensors are adapted to detect angular positions and/or angular displacement of the flywheel and to communicate corresponding data, corresponding to the angular positions and/or the angular displacement, to the processor. The engine may further include a generator cooperating with the flywheel for generation of electricity. The electricity may be used to power the processor and the pump.

### BRIEF DESCRIPTION OF THE DRAWINGS

FIG. 1 is, in cross sectional view, a sealed a container containing fluid and having a conduit passing through the container from the fluid to an actuator.

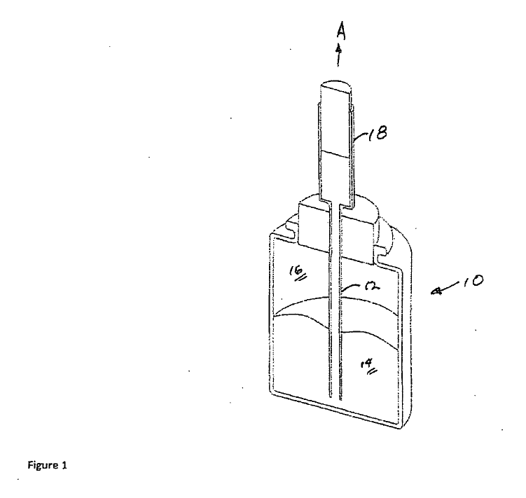

FIG. 2 is a sectional view through two sealed containers wherein one of the containers is the container of FIG. 1 modified to include a further conduit extending in fluid communication between the upper ends of the two sealed containers, and wherein only the container having the actuator contains fluid.

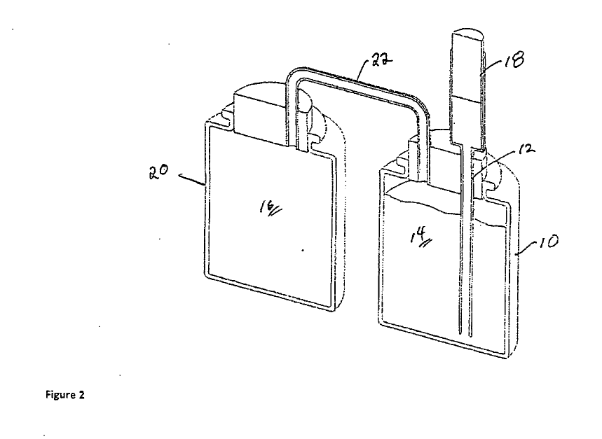

FIG. 3 is the cross sectional view of the FIG. 2 wherein the fluid has mostly been displaced from the container having the actuator into the second container.

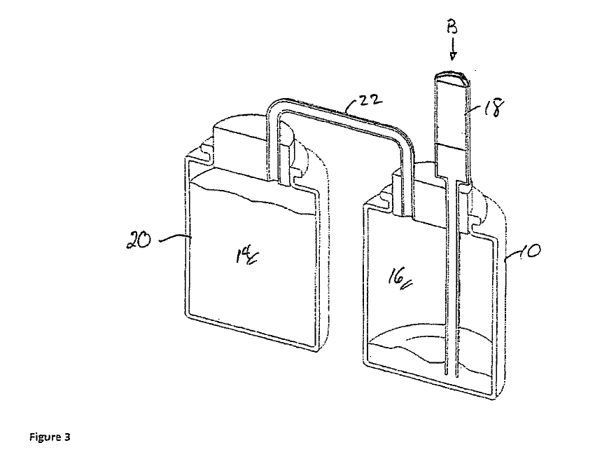

FIG. 4 is the cross sectional view of FIG. 3 of a further conduit extending in fluid communication between the two containers, this fluid communicating conduit extending to the lower ends of the containers in the manner of the actuating conduit connected to the actuator, and wherein the fluid communication has a pump cooperating with the conduit for pumping the fluid between the two containers.

FIG. 5 is a partially cutaway view of a further embodiment of one of the containers showing the use of an angled nozzle at the end of the gas communicating conduit extending between the upper ends of the two containers.

FIG. 6 is a partially cutaway view of another embodiment of a container showing a further inclined nozzle for inducing a swirling pattern of gas passing through the gas communicating conduit.

FIG. 7 is the container of FIG. 6 having cooling fins mounted in radially spaced array around the container.

FIG. 8 is, in perspective view, a piston driven flywheel cooperating with a electrical generator.

### DETAILED DESCRIPTION OF EMBODIMENTS OF THE INVENTION

The following is a description of one embodiment of a mechanism according to the present invention. The theory of operation for such a mechanism will be built up from basic principles, symbolically represented by glass jars, starting at figure one, although it is intended that the representation of glass jars is not to be limiting as other containers, including containers having different sizes and shapes would also work.

Figure one shows an enclosed container 10 with an elongate actuating conduit 12 mounted into it. The container has fluid 14 inside of it. Above the fluid is a high pressure gas 16. This gas 16 pushes on the fluid 14 sufficiently such that the fluid is pushed into the actuating conduit 12.

If the container is heated from some initial temperature, the heated gas will expand and push on the fluid, causing the piston 18 inside the actuator housing to be moved in an outward direction A.

If the temperature of the container is brought back to its initial condition, the gas will contract forming a slight vacuum on the fluid and cause the piston to move back or retract to its initial position.

Figure two shows the same setup as figure one apart from the high pressure gas being placed in a separate container 20. If this separate container is heated or cooled, the piston 18 will move as described above. The upper ends of the two containers are in fluid (gas) communication through conduit 22. In the claims hereto, container 20 may be referred to as the first container and container 10 may be referred to as the second container.

For this description container 20 will be considered to be heated and container 10 will be considered to be cooled. The mechanism as shown would put the piston 18 in its outmost position.

In Figure three much of the fluid 14 which was in container 10 in figure two has been transferred into the heated container 20. In this condition, the average gas temperature is near the temperature of the cooled container 10. At this low temperature, the piston 18 will be at its most retracted position, having retracted in direction B.

The engine of Figure four includes a means to pump fluid back and forth from the containers. An in-line pump 24 on conduit 26 is illustrated by way of example. The piston 18 can be moved inwardly and outwardly, i.e. extended or retracted, as desired by pumping fluid 14. The moving fluid 14 displaces the working gas 16 and the working gas is then heated or cooled.

In order for a system like this to be efficient, the working gas must be heated and cooled quickly. This problem may be solved by injecting the working gas into the containers in an efficient manner. Such a manner is demonstrated in figure five by way of example.

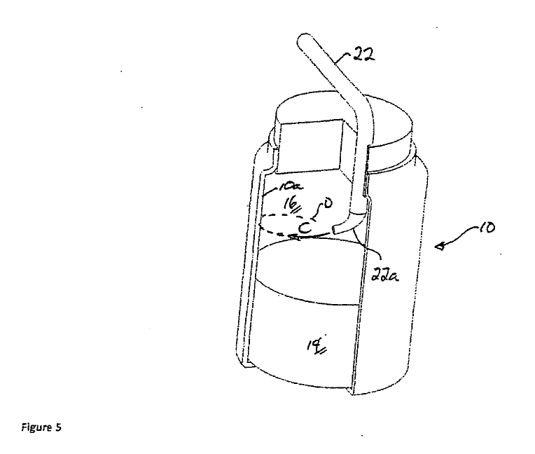

The working gas in FIG. 5 is injected through nozzle 22a into the container 10 shown as direction C, tangentially, to the container wall 10a. As well the flow should be angled downwardly. The same applies to container 20 and the opposite end of conduit 22. If the gas is injected in this manner, the flowing gas will travel in a helical path D (dotted outline) continuously contacting the container wall 10a. As the gas travels, it transfers heat to and from the container.

The question is, can the piston 18 perform more work than was done by the pump 24?

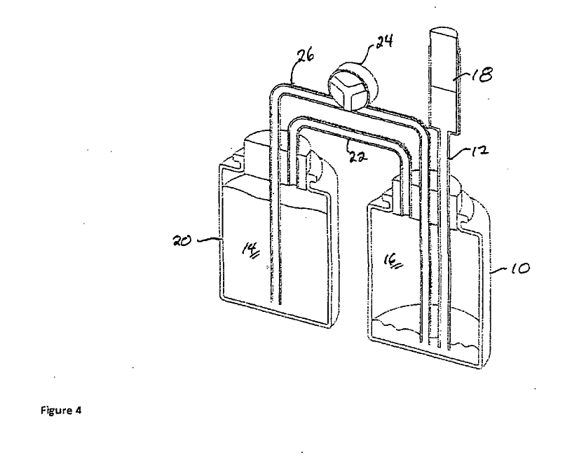

In the claims hereto, with reference to FIG. 4 by way of example, the first conduit is conduit 22, the second conduit is conduit 26 and the third conduit is conduit 12. The first end of conduit 12 is the lowermost end which, by way of example, may be ½ inch from the bottom of container 10. Container 10 may be the above ground chamber of the engine, and thus container 20 may be the under-ground chamber. The fluid motivated actuator is, by way of example, piston 18, although as would be known to those skilled in the art, many other forms of actuator may be actuated by a pressurized fluid, be it a gas or liquid.

The following is a mathematical development to show the work on the piston verses the work to move the fluid.

The ideal gas law for a system of two temperatures and the same number of moles is,

P₁V₁=nRT₁=P₂V₂=nRT₂

If we assume that there is a constant load, on the piston. Then we would have a constant pressure. Therefore P₁ would equal P₂. We can factor these out, along with n and R, and simplify yielding,

$$\frac{{V}_{1}}{{T}_{1}} = \frac{{V}_{2}}{{T}_{2}}$$

Solving for the new expanded volume yields,

$${V}_{2} = \text{?} ( \frac{{T}_{2}}{{T}_{1}} )$$

$$\text{?} \text{indicates text missing or illegible when filed}$$

The change in volume is,

ΔV=V₂−V₁

Substituting for the expanded volume yields,

$$Δ V = \text{?} ( \frac{{T}_{2}}{{T}_{1}} ) - {V}_{1}$$

$$\text{?} \text{indicates text missing or illegible when filed}$$

Factoring the initial volume to the left yields,

$$Δ V = {V}_{1} [ \frac{{T}_{2}}{{T}_{1}} - 1 ]$$

The stroke length of the cylinder is,

$$Δ L = \frac{Δ V}{A}$$

Where “A” is the cross sectional area of the piston,
Substituting for the change in volume yields,

$$Δ L = \frac{{V}_{1}}{A} [ \frac{{T}_{1}}{{T}_{2}} - 1 ]$$

Work on a cylinder is known to be

Wₗ=PAΔL

Substituting the cylinder stroke length yields,

$${W}_{1} = PA \cdot \frac{{V}_{1}}{A} [ \frac{{T}_{2}}{{T}_{1}} - 1 ]$$

Canceling out the cylinder cross sectional area yields,

$${W}_{1} = {PV}_{1} [ \frac{\text{?}}{{T}_{1}} - 1 ]$$

$$\text{?} \text{indicates text missing or illegible when filed}$$

Now let's generate an equation for the work on the fluid.

W_{f}=PD

The force is equal to the density of the fluid times the volume. Therefore,

W_{f}=ηV₁D

Let's now evaluate the net work on the system.

ΔW=Wₗ−W_{f}

Substituting the derived work equations yields,

$$Δ W = {PV}_{1} [ \frac{{T}_{2}}{{T}_{1}} - 1 ] - {pV}_{1} D$$

This equation shows that as the operating pressure increases, the work to move the fluid becomes less and less significant.

To show this more conclusively, let's calculate the fraction of the work to move the fluid over the net work. This is as follows,

$$R = \frac{{pV}_{1} D}{{PV}_{1} [ \frac{{T}_{2}}{{T}_{1}} - 1 ] + {pV}_{1} D}$$

As the operating pressure increases, the fraction of the fluid moving work, “R” is reduced asymptotically.

The mechanical advantage of the work provided by the pump to the work produced by the system is as follows,

$$E = \frac{{P}_{1} {V}_{1} [ \frac{{T}_{2}}{{T}_{1}} - 1 ]}{{pV}_{1} D}$$

The following are a few notes about the operation of this system. The cylinder performing work has been described as a hydraulic one. This is because Hydraulic cylinders tend to work better at very high operating pressures. This is not to say that a pneumatic cylinder could not be used. The hydraulic cylinder may be attached to the cold chamber by way of a hydraulic hose. Likewise, the hot and cold chambers may be connected to each other by way of pneumatic and hydraulic lines. The operation of this system is dependent on some form of logic controller to control the reversible pump.

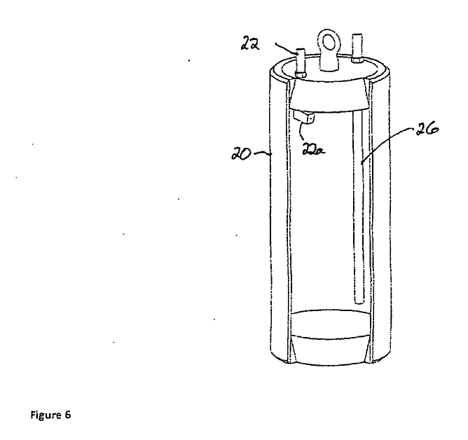

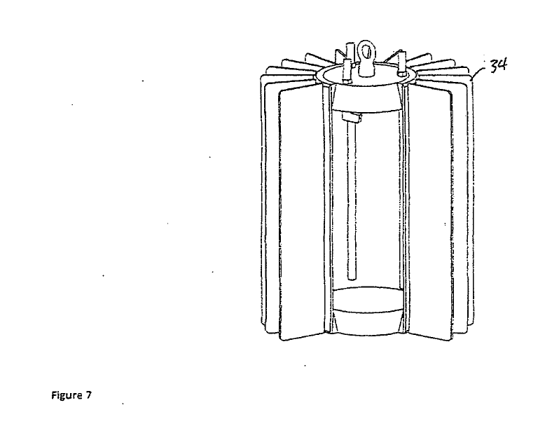

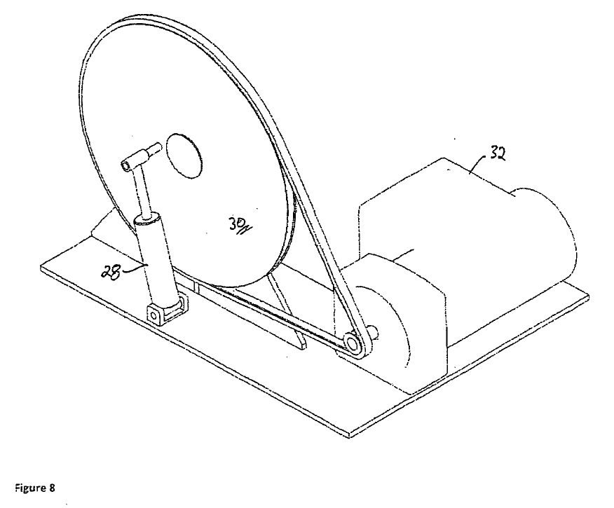

For a system to produce work from geothermal energy during a cold season the hot chamber, FIG. 6, would be buried under ground, while the cold chamber, FIG. 7, would be on the surface, connected to a piston 28, flywheel 30, and generator assembly 32, such as seen in FIG. 8. The cold chamber on the surface may have heat radiation fins 34 on its surface to enhance rapid cooling. To say the surface chamber is the cool chamber implies operation in the winter. During summer operation, the surface chamber would become the hot chamber while the ground chamber would become the cool chamber. This would not affect the operation of the system.

The Sterling cycle is characterized by isobaric heating, isothermal expansion, isobaric cooling, and finally isothermal contraction. The steps of operation of this cycle are as follows.

Starting with all the fluid in the cold chamber, the heated working gas expands and pushes on the fluid in the cold chamber, thereby pushing strongly on the piston.

After a time, the logic controller causes the pump to pump the fluid from the cold chamber to the hot chamber. This displaces the working gas from the hot chamber to the cold chamber. The working gas in the cold chamber cools down. The cooled working gas pushes weakly on the fluid and thereby the piston. The piston may then retract.

Again after a time, the logic controller (not shown) causes the pump 24 to pump the fluid from the hot chamber to the cold chamber. This displaces the working gas from the cold chamber to the hot chamber. The working gas in the hot chamber heats up. The heated working gas pushes strongly on the fluid and thereby the piston.

The following is an example of how much work could be done by a system like this.

Let's start with the input variables.
1. The hot working chamber dimensions are 24 inches Diameter by 24 inches long which equals 10,851 cubic inches.
2. The cold working chamber dimensions are 24 inches Diameter by 24 inches long which equals 10,851 cubic inches.
3. The system is pressurized to move a load of 1400 pounds through a 1 inch square piston. This requires an operating pressure of 1400 pounds per square inch.
4. The low operating temperature is 273 degrees
5. The high operating temperature is 278 degrees Kelvin.
6. The density of hydraulic fluid is 0.03168 pounds per cubic inch.
7. The distance to move the working fluid is 480 inches.
   Let's calculate the net work.

$$Δ W = {PV}_{1} [ \frac{{T}_{2}}{{T}_{1}} - 1 ] - {pV}_{1} D$$

$$Δ W = ( 1400 ) ( 10851 ) [ \frac{278}{273} - 1 ] - ( \text{?} ) ( 10851 ) ( 480 )$$

$$Δ W = 227 , 393 Joules$$

$$\text{?} \text{indicates text missing or illegible when filed}$$

If this work occurred in twenty seconds, we have 11,370 watts.
Let's evaluate the fraction of the total work used to move the working fluid.

$$R = \frac{{pV}_{1} D}{{PV}_{1} [ \frac{{T}_{2}}{{T}_{1}} - 1 ] + {pV}_{1} D}$$

$$R = \frac{( 0.03168 ) ( 1.0851 ) ( 480 )}{( 1.400 ) ( 10851 ) [ \frac{\text{?}}{273} - 1 ] + ( 0.03168 ) ( 10851 ) ( 480 )}$$

$$R = 0.372$$

$$R = 37 \%$$

$$\text{?} \text{indicates text missing or illegible when filed}$$

Next let's evaluate the mechanical advantage of the system.

$$E = \frac{\text{?} [ \frac{{T}_{2}}{{T}_{1}} - 1 ]}{{pV}_{1} D}$$

$$E = \frac{( \text{?} ) ( 10851 ) [ \frac{278}{273} - 1 ]}{( 0.03168 ) ( 10851 ) ( \text{?} )}$$

$$E = 1.69$$

$$\text{?} \text{indicates text missing or illegible when filed}$$

Consider the operation of a system using a flywheel. The orientation of the flywheel when the cylinder is at full contraction is considered to be zero degrees.

At zero degrees the fluid is in the cold chamber. Therefore the working gas is at its highest temperature. Since the working gas is at its highest temperature, the pressure on the piston is at its highest. The piston applies the highest torque to the flywheel at this stage.

When the flywheel rotates ninety degrees, the pump starts moving fluid out of the cold chamber, into the hot chamber. By the time the flywheel is at one hundred and eighty degrees, all the fluid has been moved. This moved fluid displaces the working gas to the cold chamber. The cooler gas applies a reduced pressure on the remaining fluid and piston. Inertia maintains rotation of the flywheel, against the reduced force, until the flywheel is back at zero degrees.

When the flywheel rotates two hundred and seventy degrees, the pump starts to pump the working fluid out of the hot chamber. By the time the flywheel is back at zero degrees, all of the working fluid has been moved into the cold chamber were the sequence starts all over again.

Sensor markers (not shown) are placed on the radial edge of the flywheel at positions 0 degrees, 90 degrees, 180 degrees, and finally 270 degrees. A sensor (not shown) detects the sensor markers as they pass, and communicates this information to the logic controller. The logic controller evaluates the angle of the flywheel and controls the working fluid pump 24 to maintain steady state operation.

Some of the electricity that is generated by generator 32 is stored, for example by a power management system, for use by the hydraulic pump and the logic controller.

The flywheel obtains, in a properly designed system, enough momentum to operate a load such as a generator. For the generator to obtain a high angular velocity for operation, a gear ratio may be employed from the flywheel to the generator drive shaft.

What is claimed is:

1. A mechanically decoupled, fluid displacing Sterling engine comprising:
hollow first and second containers, each of said containers having opposite upper and lower ends,
first and second fluid conduits mounted to, so as to extend between in fluid communication with, said first and second containers,
a selectively actuable fluid pump mounted in cooperation with said second conduit, said fluid pump adapted to selectively pump fluid between said containers,
a processor cooperating with said fluid pump, said processor adapted to control said pumping by said fluid pump,
wherein said first conduit only extends into said upper ends of said containers, and said second conduit extends into said lower ends of said containers,
a third fluid conduit having opposite first and second ends, said first end of said third conduit extending into said lower end of said second container, a fluid motivated actuator mounted to, in fluid communication with, said second end of said third conduit,
wherein, when said first and second containers contain an actuating volume of an actuating fluid and the balance of the volume of said containers contains a working gas, wherein said gas is expandable and contractable upon heating and cooling of said gas respectively, and wherein said actuating volume of said actuating fluid is sufficient for said pumping between said containers and for actuation along said third conduit,
whereby said expanding of said gas urges a power stroke translation of said actuator, and said volume of said containers is pressurized upon a temperature differential being applied to said first and second containers to cause said expansion of said gas,
and wherein said temperature differential is a geothermal temperature differential,
and wherein said pumping displaces said actuating fluid between said containers so as to correspondingly displace said gas for heating or cooling to provide said temperature differential to said gas.

2. The engine of claim 1 wherein said containers are hot and cold chambers of a Sterling engine, and wherein said first chamber is adapted to be installed in-ground, and said second container is adapted to be mounted above ground, and wherein during a cold season said second container is said cold chamber and said first container is said hot chamber, and wherein during a warm season said first container is said cold chamber and said second chamber is said hot chamber.

3. The engine of claim 2 wherein said processor is adapted to cause said pump to pump said actuating fluid into said cold chamber to thereby drive said gas into said hot chamber to increase said pressurization and said actuation of said actuator in said power stroke and to pump said actuating fluid into said hot chamber to thereby drive said gas into said cold chamber to reduce said pressurization and permit a reverse retracting translation of said actuator, whereby a net gain in work as between said power stroke and said pumping is achieved.

4. The engine of claim 3 wherein said first conduit has opposite ends which are oriented so as to direct a flow of said gas from each said end against an adjacent wall of said container so as to increase a rate of heat exchange between said flow and said adjacent wall.

5. The engine of claim 4 wherein said containers have curved interior surfaces and wherein said ends of said first conduit direct said flow at an acute angle against said curved interior surfaces.

6. The engine of claim 5 wherein said flow induces a swirling flow in said containers.

7. The engine of claim 6 wherein said ends are nozzles.

8. The engine of claim 7 wherein said containers are cylindrical.

9. The engine of claim 4 wherein said actuator is a piston.

10. The engine of claim 4 wherein said actuating fluid is a liquid.

11. The engine of claim 8 wherein said cold chamber includes heat radiating members.

12. The engine of claim 11 wherein said members are fins.

13. The engine of claim 9 further comprising a flywheel cooperating with, so as to be driven by, said piston.

14. The engine of claim 13 further comprising a generator cooperating with said flywheel for generation of electricity, and wherein said electricity powers said processor and said pump.

15. The engine of claim 13 further comprising sensors cooperating with said flywheel, said sensors adapted to detect angular positions and/or angular displacement of said flywheel and to communicate corresponding data, corresponding to said angular positions and/or said angular displacement, to said processor.
